(19) United States
(12) Patent Application Publication
(10) Pub. No.: US 2004/0240601 A1
(43) Pub. Date: Dec. 2, 2004

(54) Forced cooling circular deep & minus; water pond type heat supply nuclear reactor with natural circulation

(76) Inventor: Jiafu Tian, Beijing (CN)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/489,319

(22) PCT Filed: Sep. 20, 2002
(86) PCT No.: PCT/CN02/00671

(30) Foreign Application Priority Data
Sep. 21, 2001 (CN) 01131099.5

(51) Int. Cl. G21C 19/28

(52) U.S. Cl. 376/406

(57) ABSTRACT

Disclosed is a forced cooling circular deep pool nuclear heating reactor with natural circulation comprising a water pool, a reactor core, a control rod, and a heat exchanger. The reactor core is placed on the bottom of the pool, the control rod is placed inside the reactor core, the heat exchanger outlet is connected with the pool water through the circulating pump, and its inlet is connected with the reactor core. Both the heat exchanger and the circulating pump are located outside the pool, and the depth of pool water is 10-60 meters. The circulating pump is an impeller-circulating pump with high specific speed. The nuclear reactor according to the present invention adopts forced circulation with natural circulation. Thus the passive conversion from forced circulation into natural circulation is realized and the parameters such as temperature of the reactor water will not rise abruptly and will change gradually. While conversion is in progress, it can directly reduce the reactor power and lead the reactor into a shutdown status without other scram measures.

### TECHNICAL FIELD

The present invention relates to a forced circular cooling deep pool nuclear heating reactor with natural circulation, it is within the nuclear reactor technology.

### BACKGROUND OF THE INVENTION

A deep pool nuclear heating reactor is a low temperature reactor for heat supply. It works at lower temperature and provides directly the thermal energy released from nuclear fission for end-users. It makes the reactor a feature of simplicity in structure and construction with higher requirement for safety and reliability. In existing various designs, as it is shown in the patent CN85100044 which is most similar to the present invention, it is that water temperature of the reactor core outlet is allowed to increase utilizing static water pressure of a deep pool, heat exchanger is located in the pool, and full power output of the reactor is transferred by natural circulation which driven by temperature difference. In that patent it was mentioned that the circulating pump could be added to the natural circulation and the residual heat from the reactor core is still cooled by natural circulation when the reactor shutdown and the pumps are stopped. In this design, the equipment such as the heat exchangers (sometimes cum circulating pump) are all located in the pool in order to reduce circuit resistance of cooling system and full power output is all transferred by natural circulation. Due to limited natural circulation capacity, this type of design can only be used to smaller reactor for low temperature heat supply. Other more, it is not allowed to use the conventional equipments inside the pool and also it is not allowed to maintain equipments in the pool during the reactor is in operation.

As it is shown in another Chinese patent 90108540.5, which similar to the present invention, both the heat exchanger and circulating pump are located outside the pool, which is a loop-type circular cooling, and a gas lock is mounted on the pipeline in the pool. Full power output of the reactor is transferred by forced circulation, and the residual heat from the reactor core is directly cooled by natural circulation of pool water when the pumps stopped and the gas lock is opened. The reactor stops result from the control rods dropped according to the signal of control system or the water level. In this design, reliability of the gas lock needs to be validated and parameter of the gas lock needs to be monitored and controlled during the reactor operations.

### SUMMARY OF THE INVENTION

It is, therefore, the object of the present invention to provide a forced circular cooling deep pool nuclear heating reactor with natural circulation that use the conventional facilities such as unspecific circulating pump, heat exchanger, concrete pool with metal liner and control rod drive in order to modify the construction of the prior art, to increase reactor safety and reliability and to supply heat with simplicity and safety.

The object of the present invention is achieved by a forced circular cooling deep pool nuclear heating reactor with natural circulation including a water pool, a reactor core, a control rod, and a heat exchanger. The reactor core is placed on the bottom of the pool. The control rod is placed inside the reactor core. The heat exchanger outlet is connected with the pool water through a circulating pump, and the heat exchanger inlet is connected with the reactor core. The heat exchanger and the circulating pump are located outside the pool. The depth of pool water is 10-60 meters. The circulating pump is an impeller-circulating pump with high specific speed.

In addition, the reactor of the present invention comprises an inertia water tank which including a water tank body and a backwater bend. The backwater bend is located below the water tank body. The inertia water tank is connected with the pipeline, which is connected between the reactor core and the circulating pump, through the backwater bend. The water tank body is divided to inner tank and outer tank by a separator plate which having a throttle hole. The top of the inner tank and outer tank is connected with the inertia water tank outlet.

In addition, the reactor of the present invention comprises an underwater interlayer. The underwater interlayer is located under water.

The pool of above reactor can consists of two pools. The reactor core is located on the bottom of the first pool and the heat exchanger outlet is connected with the second pool through the circulating pump. The heat exchanger inlet is connected with the reactor core through the second pool.

The reactor core according to the present invention is located on the bottom of the pool. The depth of pool water is 10-60 meters. Both of the heat exchanger and the circulating pump are located outside the pool. The loop-type cooling of the reactor adopts forced circulation with natural circulation. The conversion from forced circulation to natural circulation will be a passive conversion in which the parameters such as the temperature of the reactor water will not rise abruptly and will change gradually. When the conversion is in progress, it can reduce the reactor power directly and lead the reactor into a shutdown status without other scram measures.

The forced circular cooling deep pool nuclear heating reactor with natural circulation according to the present invention has the following advantages:

1. The pressure on the surface of the pool water is normal pressure. The pipes of the reactor core outlet perforate through the wall of the pool underwater. The circulating pumps and the heat exchangers are located outside the pool, and the reactor power output is transferred by forced circulation with loop-type cooling.

2. A centrifugal pump is generally used for forced circulation, but according to the present invention, an impeller-circulating pump with high specific speed, which is achieved from mixed flow pump, is used in order to cool the reactor by natural circulation when the circulating pump is stopped. Based on the calculation of circular loop designed and experimental data of impeller resistance of various pumps, the pump with high specific speed, such as mixed flow pump or axial pump is adopted. Due to the water depth of the deep pool reactor, the circulating pump and the heat exchanger can be located over the reactor core high enough. When the parameters of the core, heat exchanger and cooling loop are designed all to meet the requirements of the pump with high specific speed, the forced cooling circulation with natural circulation can be realized. For example, for a reactor with power output of 100 MW, when a mixed flow pump is used and the cold source is located 10 meters over the heat source, the capability of natural circulation for cooling residual heat is about 10% of the power output.

3. According to the present invention an inertia water tank is located on the circulating pipeline in the pool. When the circulating pump is operating, water is discharged from the inertia water tank automatically. If the inertia water tank is located on the other position of the circular pipeline, water can be charged into the inertia water tank. When the circulating pump stops, water is charged (or discharged) automatically into the inertia water tank through the throttle hole for compensating the flow rate across the reactor core, and it makes sure that in more than 10 seconds after reactor shutdown resulted from accidental pump stopped, the decay time of total flow rate across the reactor core is more than the decay time of the reactor power. Thus the passive conversion from forced circulation into natural circulation is realized while the parameters such as temperature of the reactor water will not rise abruptly and will change gradually.

4. The calculation of the transient characteristics shows that when all the external power supplies are suddenly lost and all the scram measures, including control rods falling down and boric water ejecting, are unavailable at the same time, the above-mentioned conversion from forced circulation into natural circulation will lead to decrease power level and eventually maintain a hot shutdown status. Therefore the safety level of the water cooling reactors will be improved dramatically.

5. Due to the higher temperature of pool water surface, the heavy water vapor is a disadvantage for installing some equipment in the pool top, such as control rod drive, and it also overloads the operation of ventilating system that located at pool top. In order to avoid the amount of vaporizing water, an insulated interlayer is installed underwater. The lower temperature water flows into upside of the interlayer and then leaks into underside through the gap of interlayer. The lower temperature water can come from circulating water of decontaminating system. The water temperature above the interlayer is kept at less than 40˜50° C. It looks like a “waterseal”, thus the water vapor will not go up to the pool top.

6. Because the reactor consists of two pools, special requirement of refueling can be satisfied, and the especial control rod drive can be arranged. The cooling loop can be placed in a large space. This double pool system has the same characteristic with the deep pool reactor.

### BRIEF DESCRIPTION OF THE DRAWING

The present invention is illustrated by way of example, and not by limitation, in the figures of the accompanying drawings, wherein elements having the same reference numeral designations represent like elements throughout and wherein:

FIG. 1 illustrates the structure of the forced circular cooling deep pool nuclear heating reactor with natural circulation according to the present invention.

FIG. 2 illustrates the forced circular cooling deep pool nuclear heating reactor with natural circulation which having an inertia water tank according to the present invention.

FIG. 3 illustrates the structure of the inertia water tank according to the present invention.

FIG. 4 illustrates the structure of the deep pool reactor with underwater interlayer according to the present invention.

FIG. 5 is an embodiment of the present invention.

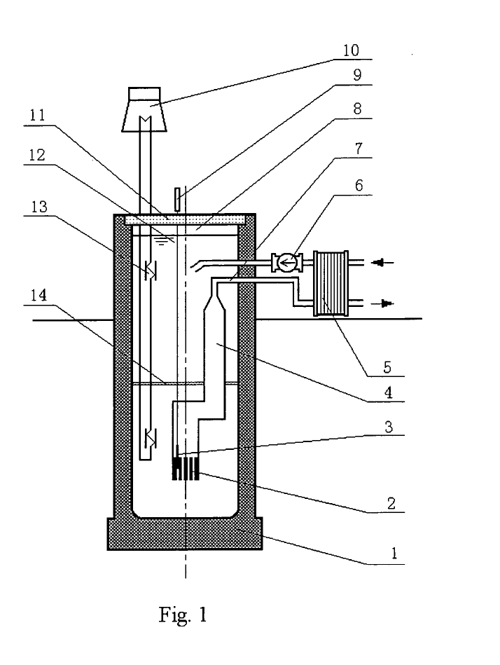

From FIG. 1 to FIG. 5, 1 refers to the concrete pool; 2 refers to the reactor core; 3 refers to the control rod; 4 refers to the activity decay tank; 5 refers to the heat exchanger; 6 refers to the circulating pump; 7 refers to the activity decay tank outlet circulating pipeline. 8 refers to the pool top space; 9 refers to the control rod drive; 10 refers to the cooling tower of the pool water; 11 refers to the pool cover; 12 refers to the pool water; 13 refers to the heat exchanger for cooling the pool water; 14 refers to the underwater maintenance platform; 15 refers to the inertia water tank; 16 refers to the underwater interlayer; 17 refers to the inner space of the backwater bend near the inertia water tank inlet; 18 refers to the outer space of the backwater bend near the inertia water tank inlet; 19 refers to the throttle hole on the separator plate of the inertia water tank; 20 refers to the outer tank of the inertia water tank; 21 refers to the inner tank of the inertia water tank; 22 refers to the inertia water tank outlet connected with pool top space; 23 refers to the surface of the pool; 24 refers to the surface of the inertia water tank; 25 refers to the first pool of the deep pool; 26 refers to the hot pipe between the first pool and the second pool; 27 refers to the second pool of the deep pool; 28 refers to the activity decay room; 29 refers to the cold pipe between the first pool and the second pool; 30 refers to the inner cover of the first pool; 31 refers to the outer cover of the first pool.

### BEST MODE FOR CARRYING OUT THE INVENTION

FIG. 1 illustrates the structure of the forced cooling circular deep pool nuclear heating reactor with natural circulation according to the present invention.

As shown in FIG. 1, reactor pool 1 is made of reinforced concrete. The metal liner sticks on the inner wall of the reactor pool. The reactor pool is full by demineralizing water 12 and is covered with a cover 11. The pool top space 8 is at normal pressure. The core 2 is placed on the bottom of the pool. Pool water enters into the core from the bottom and flows out from the core top after it is heated, then flows out the pool through activity decay tank 4 and circular pipe 7 of activity decay tank outlet. When the water is in the heat exchanger 5, it is cooled down, and then enters into the circulating pump 6 and returns to the pool. When the reactor is in operation, the control rod 3 driven by the control rod drive 9 controls the reactor, which is controlled at optimum output rating, and the circular flow driven by the circulating pump 6 transfers reactor output to meet the demand of the operation.

After the reactor was stopped, the circulating pump 6 could be stopped subsequently. A part of pool water is driven by density difference between hot and cold water to flow in succession through the core, the loop pipe, the heat exchanger and the impeller of the circulating pump, and to transfer the residual heat from the reactor. Pool water cooling system consists of the heat exchanger 13 for cooling pool water and the cooling tower 10 for pool water, the circulating water in the pipe of the cooling system flows by nature circulation to keep pool water at moderate temperature for a long time. During the reactor is refueling, a part of pool water would be discharged to the other pool and the refueling and maintenance will be operating on the underwater maintenance platform 14.

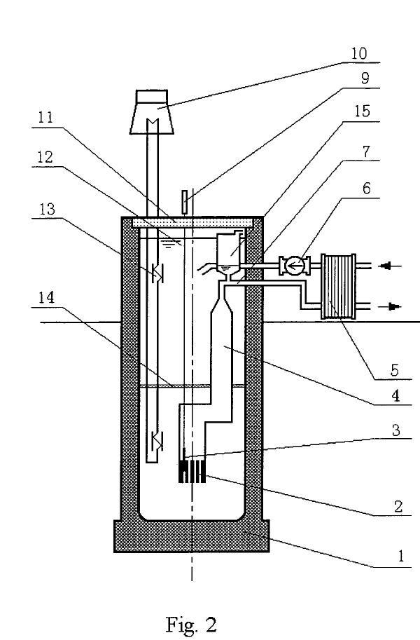

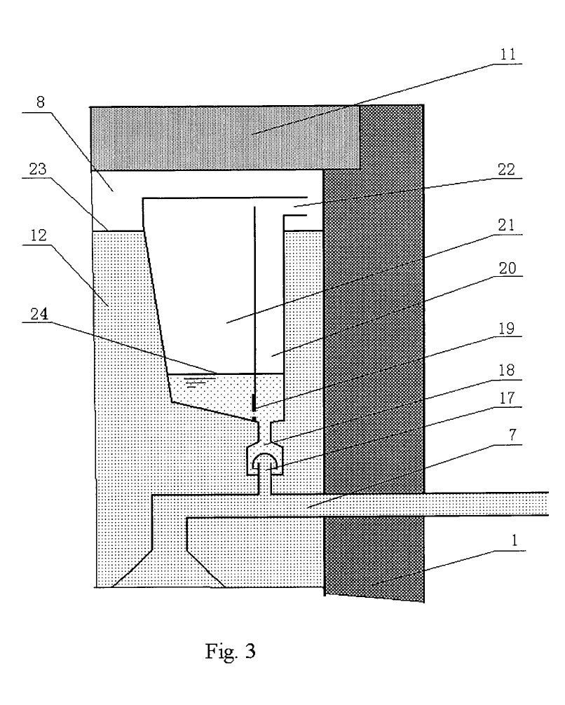

FIG. 2 illustrates the structure of the forced circular cooling deep pool nuclear heating reactor with natural circulation which having an inertia water tank according to the present invention. As shown in FIG. 2, the inertia water tank 15 is installed on the circular pipe 7 of activity decay tank outlet showing in FIG. 1 according to the present invention. The structure of the inertia water tank according to the present invention is as shown in FIG. 3.

As shown in FIGS. 2 and 3, the outer tank and the inner tank of inertia water tank 20 and 21 are connected with the circulating pipeline 7 of activity decay tank outlet. Due to lower water temperature within the inertia water tank (same with pool water) and higher water temperature within the circulating pipeline 7 of activity decay tank outlet, a backwater bend is located at and connected with the inertia water tank inlet. The inner space 17 of the backwater bend is connected with the circulating pipeline 7 of activity decay tank outlet, within which water temperature is higher. The outer space 18 of the backwater bend is connected with the inertia water tank, within which water temperature is lower. If gas is being in the backwater bend, it is allowed since the inertia water tank cannot fail in this condition. The inertia water tank is divided to inner tank 21 and outer tank 20 by a separator plate. The top of the inner tank and outer tank is connected with each other, and is connected with the pool top space 8 through the tank outlet 22.

When the circulating pump 6 is stopped, water level inside and outside the inertia water tank 15 is at the same level. When the circulating pump 6 starts to operate, water level inside the inertia water tank decreases gradually because the circular pipe 7 of activity decay tank outlet is located between the core 2 and the circulating pump 6, the water pressure inside activity decay tank is lower than that of pool water outside the inertia water tank. When the circulating pump is in normal operation, pool water level is at the position shown as No. 23; the level inside the inertia water tank is at the position shown as No. 24.

When all the external power supplies are lost suddenly, circulating pumps 6 are all stopped accordingly, the circular flow rate decreases inertially. At the same time, after power supplies failure, the control rods drop controlled by the control system and the reactor shutdown accordingly. During more than 10 seconds after that happened, the reactor power level decreases frequently slower than that of the circular flow rate, thus the water temperature of the core outlet would increase. According to the present invention, the above situation can be eliminated. When the circulating pump stops, the water level inside the inertia water tank 20 and 21 rises and pool water will flow into the inertia water tank through the core 2. The water flow rate is determined by the cross section of the inertia water tank 21 and the size of the throttle hole 19 on the separator plate in inertia water tank. The inertia water tank 21 and the size of the throttle hole 19 are determined for slower decreasing the circular flow rate across the core 2 than that of the reactor power level, during more than 10 seconds after reactor shutdown and circulating pump stopped. After more than 10 seconds, water level inside the inertia water tank 20 and 21 is same as pool water level 23. In the present invention, the natural circulation in primary loop, driven by temperature difference, has enough capability to transfer residual heat from the reactor, therefore the reactor cooling can be kept for a long time.

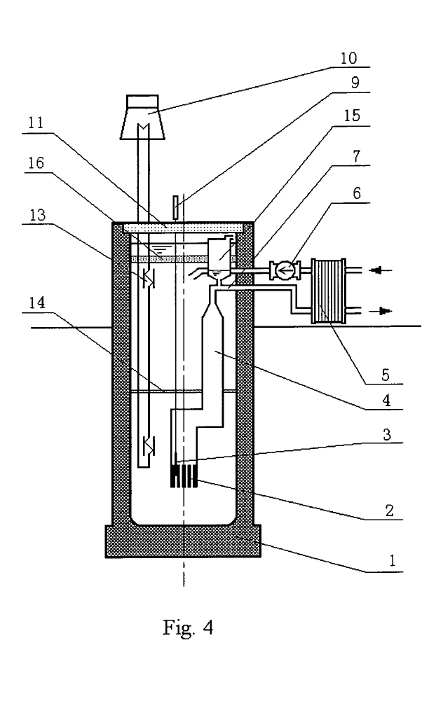

FIG. 4 illustrates the structure of the deep pool reactor with underwater interlayer according to the present invention.

As shown in FIG. 4, in the reactor pool showing in FIG. 1 according to the present invention, an underwater interlayer 16 is set underwater, and water above the interlayer is at lower temperature about 40˜50° C. The lower temperature water could be backwater from purification system or cooling water from a cooler that is set purposely. The lower temperature water above the interlayer leaks into lower side through gap of the interlayer preventing the higher temperature water under the interlayer to rise up to the surface and creating a waterseal to avoid large volume of water vapor.

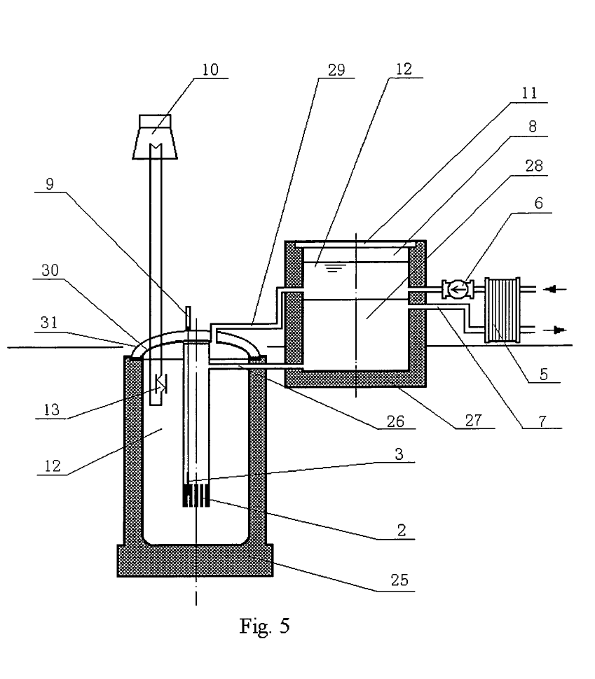

FIG. 5 illustrates the structure of the deep pool reactor with two pools according to the present invention.

As shown in FIG. 5, the reactor deep pool consists of the first pool 25 and second pool 27 and they are connected by the hot pipe 26 and cold pipe 29. The static water pressure in the core 2 is depended upon the height of water level in the second pool 27. The function of the activity decay tank 4 is achieved by the activity decay room 28 in the second pool 27. An inner cover 30 and outer cover 31 are added to first pool 25. The control rod drive can be installed in the covers. When the reactor needs to refueling, the valves on the hot pipe 26 and the cold pipe 29 between the two pools are closed and the outer cover 31 and the inner cover 30 of first pool are opened. In this design, the other functionality of the deep pool reactor and cooling system such as that of the forced cooling circulation with natural circulation, the inertia water tank 15, and the underwater interlayer 16, are all same with before-mentioned.

The above deep pool reactor can be also consisted of multi-pools which are connected each other by pipelines.

What is claimed is:

1. A forced circular cooling deep pool nuclear heating reactor with natural circulation, comprising a water pool, a reactor core, a control rod, and a heat exchanger; said reactor core being placed on the bottom of said pool, said control rod being placed inside said reactor core; said heat exchanger outlet being connected with the pool water through a circulating pump, and said heat exchanger inlet being connected with said reactor core; wherein said heat exchanger and said circulating pump are located outside the pool; the depth of said pool water is 10-60 meters; said circulating pump is an impeller-circulating pump with high specific speed.

2. The nuclear heating reactor of claim 1, comprising an inertia water tank, said inertia water tank being located on circulating pipeline for cooling said reactor core

3. The nuclear heating reactor of claim 1, comprising an underwater interlayer; said underwater interlayer being located under water.

4. The nuclear heating reactor of claim 1, wherein said pool consists of two pools; said reactor core is located at the bottom of the first pool and said heat exchanger outlet is connected with the second pool through said circulating pump; said heat exchanger inlet is connected with said reactor core through the second pool.

5. The nuclear heating reactor of claim 4, comprising a inertia water tank, said inertia water tank being located on circulating pipeline for cooling said reactor core.

6. The nuclear heating reactor of claim 4, comprising an underwater interlayer; said underwater interlayer being located under water.
